(19) United States
(12) Patent Application Publication
(10) Pub. No.: US 2019/0341176 A1
(43) Pub. Date: Nov. 7, 2019

(54) PRESSURE-SENSITIVE DEVICE, HAND, AND ROBOT

(71) Applicant: Seiko Epson Corporation, Tokyo (JP)

(72) Inventor: Fumio TAKAGI, Chino (JP)

(21) Appl. No.: 16/403,733

(22) Filed: May 6, 2019

(30) Foreign Application Priority Data
May 7, 2018 (JP) 2018-089079

(51) Int. Cl. H01C 10/12; H01C 1/14; H01C 1/014; B25J 13/08

(52) U.S. Cl. CPC H01C 10/12; H01C 1/14; B82Y 30/00; B25J 13/082; H01C 1/014

(57) ABSTRACT

A pressure-sensitive device includes a resin mixture in which a carbon nanotube is mixed, an electrode stacked on the resin mixture, and a pressurization unit that pressurizes the resin mixture in a direction of the stacking, wherein the pressurization unit includes an adjustment mechanism of adjusting an amount of the pressurization. Further, the pressurization unit has a first board, a second board placed along a direction of stacking on the first board, and a screw as the adjustment mechanism, and a distance between the first board and the second board changes by turning of the screw, and thereby, the amount of pressurization is adjusted.

The present application is based on and claims priority from JP Application Serial Number 2018-089079, filed May 7, 2018, the disclosure of which is hereby incorporated by reference herein in its entirety.

### BACKGROUND

### 1. Technical Field

The present disclosure relates to a pressure-sensitive device, hand, and robot.

### 2. Related Art

For example, JP-A-1-150825 discloses a load sensor sandwiching a pressure-sensitive conducting rubber with a pair of electrodes and measuring a load using a change in resistance value of the pressure-sensitive conducting rubber due to the applied load.

JP-A-1-150825 is an example of the related art.

However, in the load sensor of JP-A-1-150825, a silicone rubber or the like containing conducting particles of carbon or the like dispersed therein is used as the pressure-sensitive conducting rubber. When the pressure-sensitive conducting rubber is used, in a region with a lower load, the change in resistance value of the pressure-sensitive conducting rubber becomes too large relative to the change in load, and thereby, the measurement value of the applied load varies and the load is not accurately measurable (see FIG. 3).

### SUMMARY

A pressure-sensitive device according to an aspect of the present disclosure includes a resin mixture in which a carbon nanotube is mixed, an electrode stacked on the resin mixture, and a pressurization unit that pressurizes the resin mixture in a direction of the stacking, wherein the pressurization unit includes an adjustment mechanism of adjusting an amount of the pressurization.

### BRIEF DESCRIPTION OF THE DRAWINGS

FIG. 1 is a sectional view of a pressure-sensitive device according to a first embodiment of the present disclosure.

FIG. 2 is a graph showing load-resistance characteristics of the pressure-sensitive device.

FIG. 3 is a graph showing the load-resistance characteristics without pressurization.

FIG. 4 is a graph showing the load-resistance characteristics with pressurization.

FIG. 5 is a graph showing measurement value variations in the cases with pressurization and without pressurization.

FIG. 6 is a graph showing load-resistance characteristics when PC is used as a resin.

FIG. 7 is a graph showing load-resistance characteristics when PC is used as the resin.

FIG. 8 is a graph showing load-resistance characteristics when PC is used as the resin.

FIG. 9 is a graph showing load-resistance characteristics when PC is used as the resin.

FIG. 10 is a graph showing measurement value variations when PC is used as the resin.

FIG. 11 is a graph showing load-resistance characteristics when PP is used as a resin.

FIG. 12 is a graph showing load-resistance characteristics when PP is used as the resin.

FIG. 13 is a graph showing load-resistance characteristics when PP is used as the resin.

FIG. 14 is a graph showing load-resistance characteristics when PP is used as the resin.

FIG. 15 is a graph showing measurement value variations when PP is used as the resin.

FIG. 16 is a graph showing load-resistance characteristics when PET is used as a resin.

FIG. 17 is a graph showing load-resistance characteristics when PET is used as the resin.

FIG. 18 is a graph showing load-resistance characteristics when PET is used as the resin.

FIG. 19 is a graph showing load-resistance characteristics when PET is used as the resin.

FIG. 20 is a graph showing measurement value variations when PET is used as the resin.

FIG. 21 is a plan view showing a hand according to a second embodiment of the present disclosure.

FIG. 22 is a sectional view of a finger unit of the hand shown in FIG. 21.

FIG. 23 is a sectional view of a pressure-sensitive device placed in the finger unit shown in FIG. 22.

FIG. 24 is a sectional view for explanation of a mechanism of sensing a load by the pressure-sensitive device.

FIG. 25 is a sectional view for explanation of the mechanism of sensing the load by the pressure-sensitive device.

FIG. 26 is a perspective view showing a robot according to a third embodiment of the present disclosure.

### DESCRIPTION OF EXEMPLARY EMBODIMENTS

As below, a pressure-sensitive device, hand, and robot according to the present disclosure will be explained in detail with reference to preferred embodiments shown in the accompanying drawings.

### First Embodiment

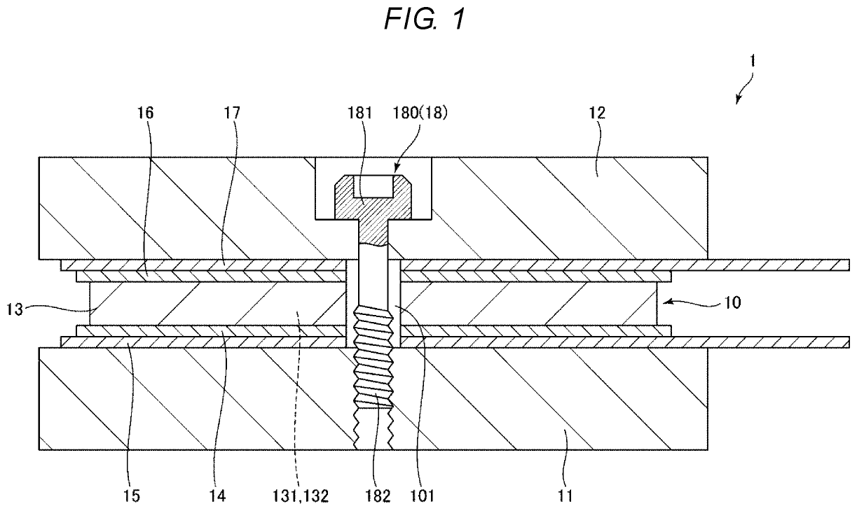

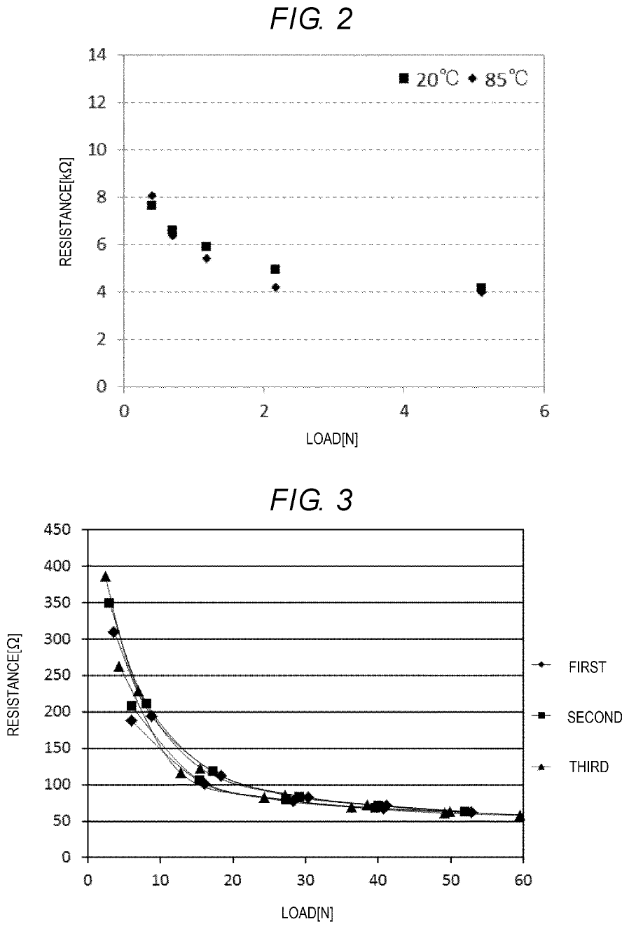

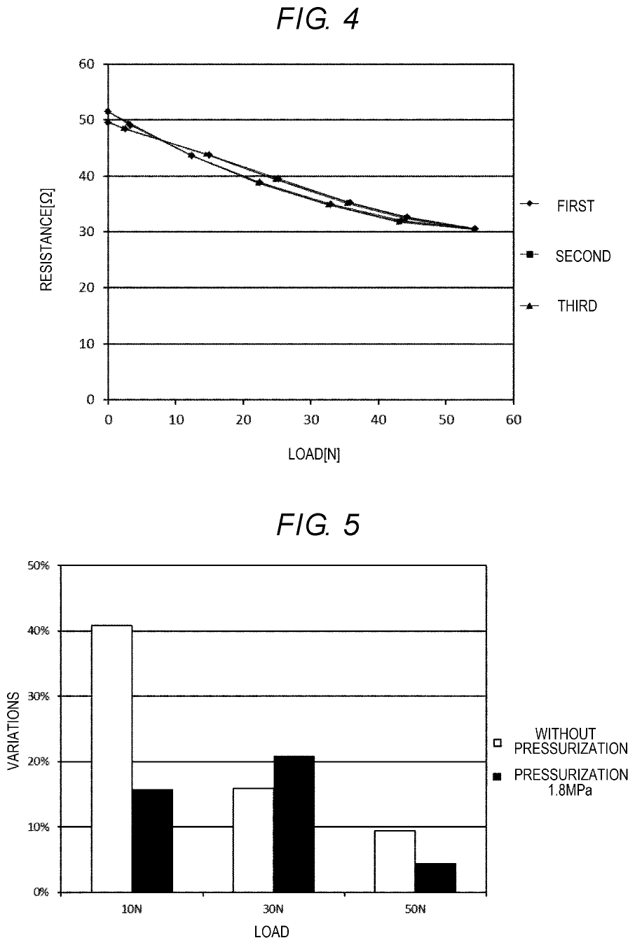

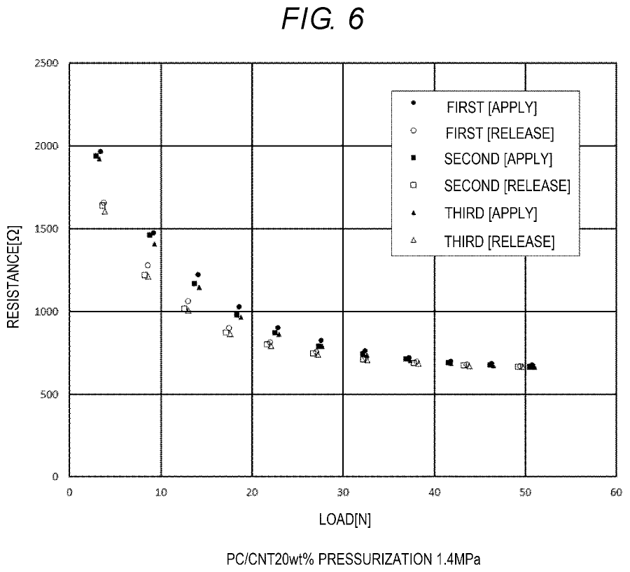

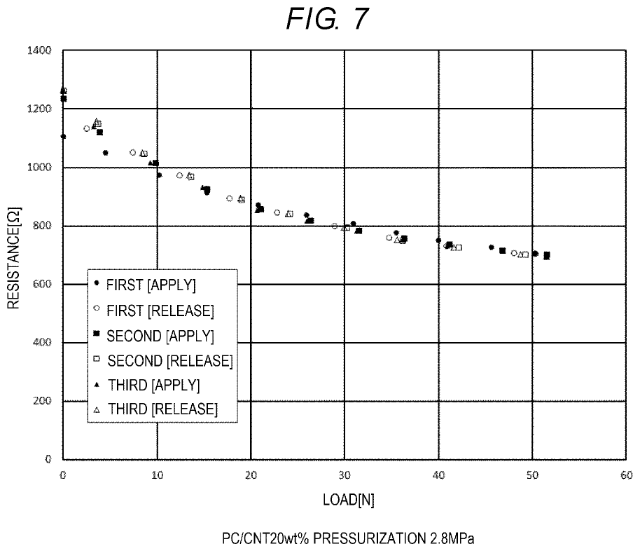

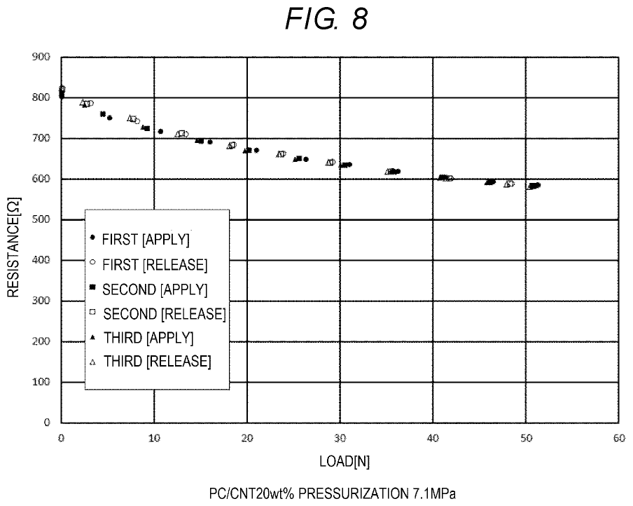

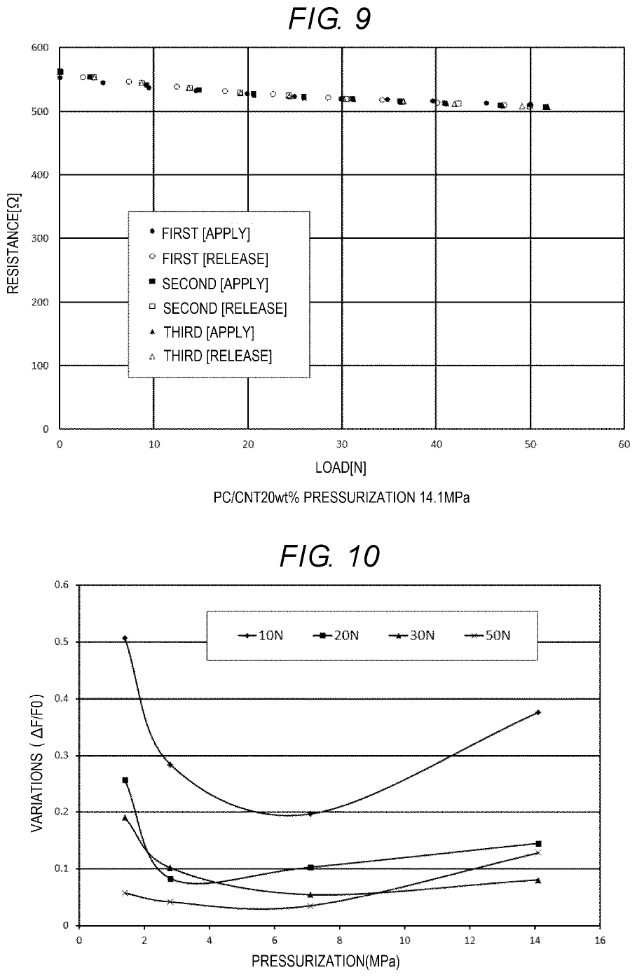

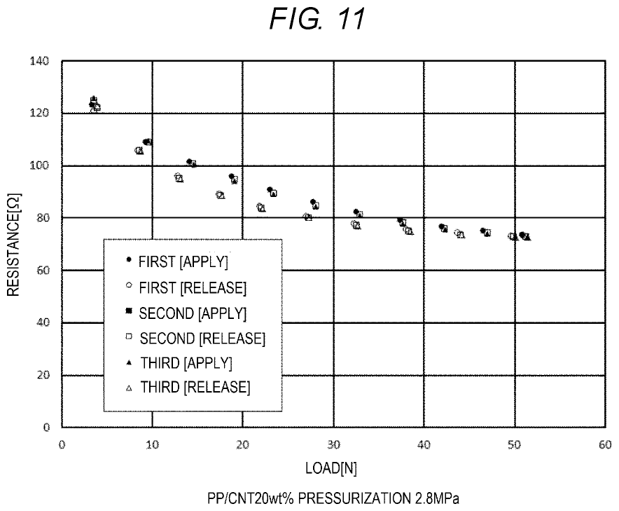

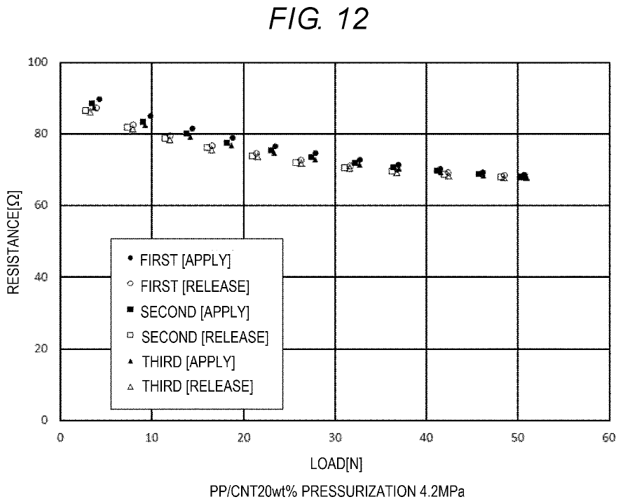

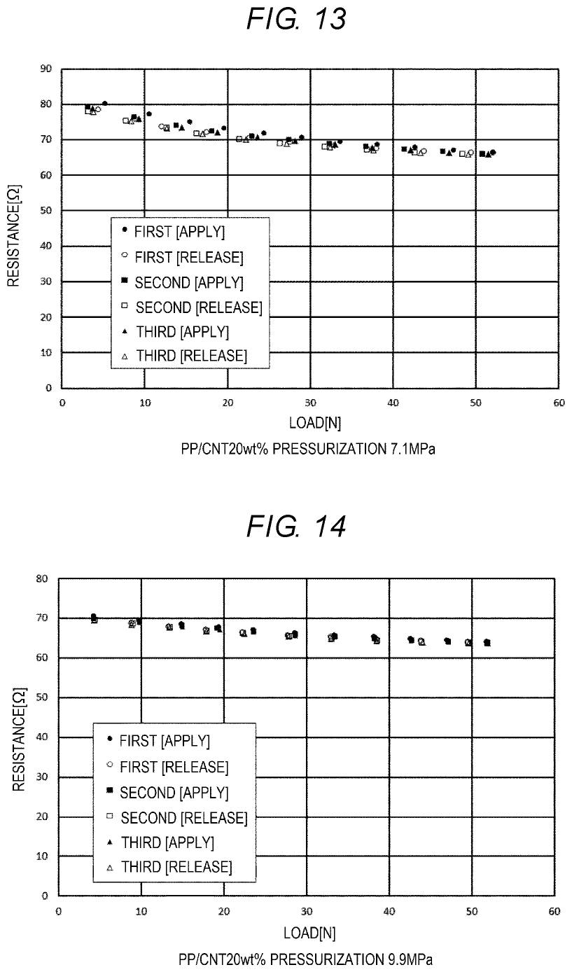

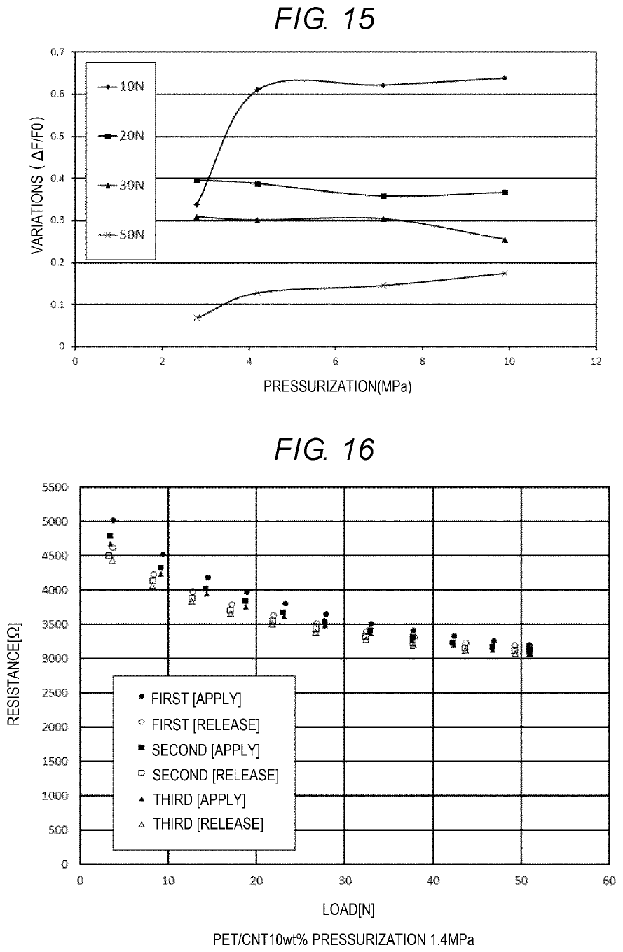

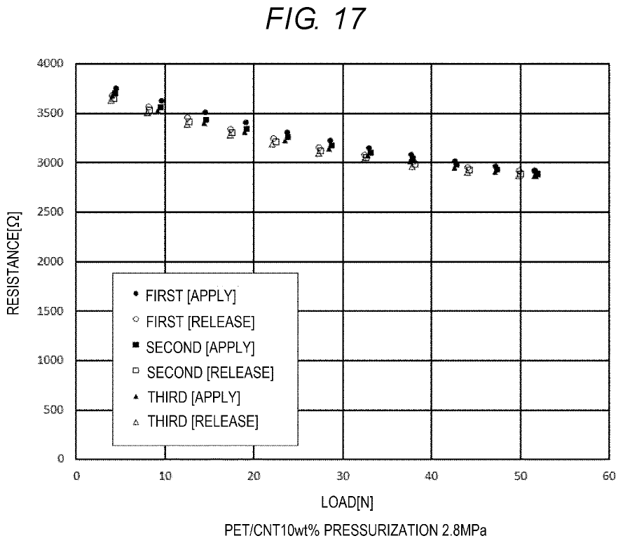

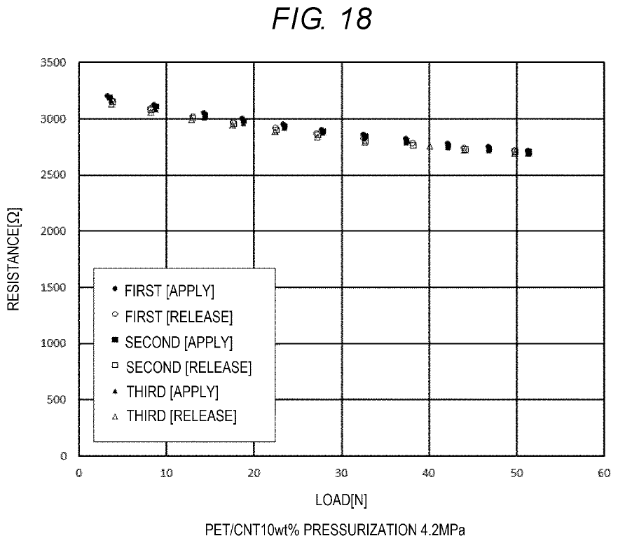

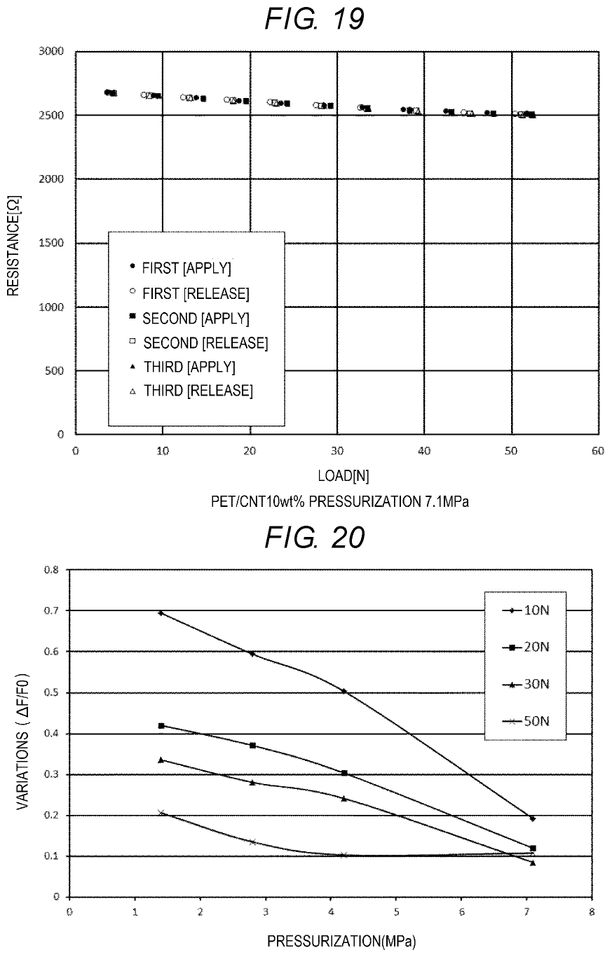

FIG. 1 is the sectional view of the pressure-sensitive device according to the first embodiment of the present disclosure. FIG. 2 is the graph showing load-resistance characteristics of the pressure-sensitive device. FIG. 3 is the graph showing the load-resistance characteristics without pressurization. FIG. 4 is the graph showing the load-resistance characteristics with pressurization. FIG. 5 is the graph showing measurement value variations in the cases with pressurization and without pressurization. FIGS. 6 to 9 are the graphs showing the load-resistance characteristics when PC is used as resin. FIG. 10 is the graph showing measurement value variations when PC is used as the resin. FIGS. 11 to 14 are the graphs showing the load-resistance characteristics when PP is used as the resin. FIG. 15 is the graph showing measurement value variations when PP is used as the resin. FIGS. 16 to 19 are the graphs showing the load-resistance characteristics when PET is used as the resin. FIG. 20 is the graph showing measurement value variations when PET is used as the resin. Hereinafter, for convenience of explanation, an upper side in FIG. 1 is also referred to as “upper” and a lower side is also referred to as “lower”.

The pressure-sensitive device 1 shown in FIG. 1 has a first board 11, a second board 12 placed to face the first board 11, a sheet-like resin mixture 13 placed between the first board 11 and the second board 12, a first electrode 14 placed between the first board 11 and the resin mixture 13, a first support board 15 located between the first board 11 and the first electrode 14 and supporting the first electrode 14, a second electrode 16 placed between the second board 12 and the resin mixture 13, and a second support board 17 located between the second board 12 and the second electrode 16 and supporting the second electrode 16. That is, the first electrode 14 and the second electrode 16 are respectively placed on surfaces of the resin mixture 13.

Further, a stacking structure of the first electrode 14, the resin mixture 13, and the second electrode 16 is referred to as “stacking structure 10”, and the pressure-sensitive device 1 has a pressurization unit 18 that pressurizes the stacking structure 10 along an axis of the thickness thereof. Here, the thickness axis of the stacking structure 10 is, in other words, an axis crossing the axis in which the surface of the resin mixture 13 with the first electrode 14 or second electrode 16 placed thereon spreads (an axis crossing the surface). The pressurization unit 18 includes one screw 180 coupling the first board 11 and the second board 12. The screw 180 has a head portion 180 engaged with the second board 12 and a thread portion 182 screwed together with the first board 11. Accordingly, when the screw 180 is fastened (turned), a gap between the first, second boards 11, 12 becomes narrower (the distance becomes smaller), and the stacking structure 10 located between the boards may be pressurized. Further, magnitude of the pressurization may be adjusted by adjusting an amount of fastening of the screw 180. According to the configuration, the screw 180 functions as an adjustment unit (adjustment mechanism) that adjusts the pressurization on the stacking structure 10.

In the pressure-sensitive device 1 having the above described configuration, when a load along the thickness axis is applied to the pressure-sensitive device 1 that is in contact with an object, contact resistances change with changes in contact area between the first, second electrodes 14, 16 and the resin mixture 13, and a resistance value between the first electrode 14 and the second electrode 16 changes. Accordingly, the pressure-sensitive device 1 may detect the applied load based on the resistance value change between the first electrode 14 and the second electrode 16. As below, the respective parts of the pressure-sensitive device 1 will be sequentially explained.

The resin mixture 13 is formed using a material (pressure-sensitive conducting resin) containing an insulating resin 131 as a base and carbon nanotubes 132 as a conducting material. That is, the carbon nanotubes 132 are mixed in the resin 131, and the resin mixture 13 is a mixture of the resin 131 and the carbon nanotubes 132. According to the configuration, the resin mixture 13 may be easily molded in a sheet shape and reduction in thickness and weight of the pressure-sensitive device 1 may be realized. Note that the resin mixture 13 may be manufactured using e.g. injection molding or extrusion molding.

The thickness of the resin mixture 13 is not particularly limited, but e.g. preferably from 50 μm to 200 μm and more preferably from 80 μm to 120 μm. Thereby, the sufficiently thin resin mixture 13 that may sufficiently fulfill the function is obtained. Accordingly, the pressure-sensitive device 1 maybe downsized while maintaining detection characteristics of the pressure-sensitive device 1. Note that “thickness” refers to an average thickness of the resin mixture 13.

The carbon nanotube 132 is used as the conducting material, and thereby, volume resistivity of the resin mixture 13 is harder to be affected by temperature, and fluctuations of the measurement value due to temperature change may be reduced. Accordingly, for example, excessive temperature correction is not necessary, and the applied load may be accurately detected. The following explains this in detail. The graph shown in FIG. 2 is the graph showing a relationship between a load applied to the pressure-sensitive device 1 and the resistance value between the first, second electrodes 14, 16 when the carbon nanotube is used as the conducting material. As can be seen from FIG. 2, the load-resistance value characteristics are nearly the same between the case at 20° C. and the case at 85° C. Accordingly, the carbon nanotube is used as the conducting material, and thereby, the temperature dependence of the resin mixture 13 is lower and the fluctuations of the detection signal due to temperature change may be reduced.

Further, the carbon nanotube 132 is used as the conducting material, and thereby, for example, compared to a case where carbon is used as the conducting material in a related art, the resistance value of the resin mixture 13 (electrical resistance between the first, second electrodes 14, 16) maybe made sufficiently lower with a smaller content. Accordingly, mixing with the resin 131 is easier.

Note that the Young's modulus of the resin mixture 13 is not particularly limited, but e.g. preferably from 1.5 times to 2 times the Young's modulus of the resin 131. Specifically, the Young's modulus of the resin mixture 13 is preferably from 4 GPa to 6 GPa. Thereby, the resin mixture 13 is sufficiently hard and the detectable range is wider, and higher loads may be detected. Further, excessive hardening may be suppressed and degradation of the detection characteristics for lower loads maybe effectively suppressed.

A diameter of the carbon nanotube 132 is not particularly limited, but e.g. preferably from 100 nm to 200 nm and more preferably from 130 nm to 160 nm. Further, a length of the carbon nanotube 132 is not particularly limited, but e.g. preferably from 2 μm to 10 μm and more preferably from 3 μm to 8 μm. With this diameter and the length, aggregation of the carbon nanotubes maybe prevented and a stable resistance value may be obtained. Accordingly, the load applied to the pressure-sensitive device 1 may be detected with higher accuracy. Note that “diameter” refers to an average diameter of the plurality of carbon nanotubes 132 contained in the resin mixture 13, and “length” refers to an average length of the plurality of carbon nanotubes 132 contained in the resin mixture 13.

The content of the carbon nanotubes 132 in the resin mixture 13 is not particularly limited, but e.g. preferably from 2 wt % to 30 wt %, more preferably from 10 wt % to 30 wt %, and even more preferably from 20 wt % to 25 wt %. Thereby, moderate conductivity may be provided to the resin mixture 13, and reduction in mechanical strength of the resin mixture 13 due to excessive mixing of the carbon nanotube 132 may be suppressed.

The resin 131 is not particularly limited, but e.g. a deflection temperature under load thereof is preferably equal to or higher than 100° C. Note that the deflection temperature under load refers to a temperature at which magnitude of deflection becomes a constant value when a temperature of a sample is raised under a predetermined load, and the higher the temperature the higher the heat resistance. Further, the deflection temperature under load may be measured by a test method according to JIS 7191. Thereby, reduction of elasticity of the resin mixture 13 under a high-temperature environment may be suppressed, and the pressure-sensitive device 1 may exert the same detection accuracy even under the high-temperature environment as that under a normal-temperature environment or low-temperature environment.

Further, the resin 131 is not particularly limited, but, for example, the Young's modulus thereof is preferably equal to or higher than 1 GPa, more preferably equal to or higher than 1.5 GPa, and even more preferably equal to or higher than 2 GPa. Thereby, the harder resin mixture 13 is obtained and the mechanical strength of the pressure-sensitive device 1 may be improved. In addition, deformation and settling with time may be suppressed, and degradation and fluctuations of the detection characteristics with time may be suppressed.

Furthermore, the resin 131 is not particularly limited, but preferably a thermoplastic resin. Thereby, mixing of the resin 131 and the carbon nanotubes 132 is easier and dispersibility is higher, and manufacturing of the resin mixture 13 is easier. The thermoplastic resin is not particularly limited to, but includes e.g. ABS resin, PP (polypropylene), PE (polyethylene), PS (polystyrene), PMMA (polymethylmethacrylate), PET (polyethylene terephthalate), PPE (polyphenylether), PA (polyamide), PC (polycarbonate), POM (polyacetal), PBT (polybutylene terephthalate), PPS (polyphenylene sulfide), and PEEK (polyetheretherketone), and one, two, or more of the resins may be mixed for use.

Of the resins, the resin 131 preferably contains PC (polycarbonate). When the resin 131 contains PC, the resin 131 is inexpensive, easy to handle, and easily mixed with the carbon nanotubes 132. Further, the resin mixture 13 is easily formed to be harder. Accordingly, allowable load per unit area may be higher and the mechanical strength of the pressure-sensitive device 1 maybe improved, and the measurable range may be secured to be wider. In addition, deformation and settling with time of the resin mixture 13 maybe suppressed, and degradation and fluctuations of the detection characteristics with time may be suppressed. The content of PC in the resin 131 is not particularly limited, but e.g. preferably equal to or higher than 50 wt %, more preferably equal to or higher than 75 wt %, and even more preferably equal to or higher than 95 wt %. Thereby, the above described effects may be exerted more remarkably.

Further, of the resins, the resin 131 preferably contains at least one of PP (polypropylene), PET (polyethylene terephthalate), and PPS (polyphenylene sulfide). When the resin 131 contains at least one of PP, PET, and PPS, the resin 131 is inexpensive, easy to handle, and easily mixed with the carbon nanotubes 132 like PC. The contents of PP, PET, and PPS in the resin 131 are not particularly limited, but, respectively, e.g. preferably equal to or higher than 50 wt %, more preferably equal to or higher than 75 wt %, and even more preferably equal to or higher than 95 wt %. Thereby, the above described effects may be exerted more remarkably.

As shown in FIG. 1, the first board 11 and the second board 12 are placed with the resin mixture 13 in between. Specifically, the first board 11 is located on a lower surface side of the resin mixture 13 and the second board 12 is located on an upper surface side of the resin mixture 13. The first board 11 and the second board 12 are both sufficiently hard compared to the resin mixture 13. The constituent materials of the first board 11 and the second board 12 are not particularly limited, but e.g. various metal materials or various ceramic materials may be used.

Further, the first electrode 14 and the second electrode 16 are located between the first board 11 and the second board 12 and placed with the resin mixture 13 in between. Specifically, the first electrode 14 is located between the first board 11 and the resin mixture 13, and the second electrode 16 is located between the second board 12 and the resin mixture 13. The first electrode 14 is in contact with, but not joined to the lower surface of the resin mixture 13 and the second electrode 16 is is in contact with, but not joined to the upper surface of the resin mixture 13. The first, second electrodes 14, 16 are not joined to the principal surfaces of the resin mixture 13, and thereby, contact resistance between the first, second electrodes 14, 16 and the resin mixture 13 easily changes according to the load.

The constituent materials of the first electrode 14 and the second electrode 16 are not particularly limited as long as the materials have conductivity, but includes e.g. various metals such as nickel (Ni), cobalt (Co), gold (Au), platinum (Pt), silver (Ag), copper (Cu), manganese (Mn), aluminum (Al), magnesium (Mg), titanium (Ti), and tungsten (W) and alloys containing at least one of the metals, and one, two, or more of the materials may be combined (for example, as a stacking structure) for use.

Note that the placement of the first electrode 14 and the second electrode 16 is not particularly limited, but e.g. a placement in which the first electrode 14 and the second electrode 16 are insulated and disposed side by side on the upper surface side of the resin mixture 13, or a placement in which the first electrode 14 and the second electrode 16 are insulated and disposed side by side on the lower surface side.

As shown in FIG. 1, the first support board 15 is located between the first board 11 and the first electrode 14. Further, the first electrode 14 is provided on an upper surface of the first support board 15 and a wire (not shown) of the first support board 15 is electrically coupled to the first electrode 14. Thereby, the first electrode 14 may be easily extracted from between the first, second boards 11, 12. Note that the first support board 15 may be omitted.

Similarly, the second support board 17 is located between the second board 12 and the second electrode 16. Further, the second electrode 16 is provided on a lower surface of the second support board 17, and a wire (not shown) of the second support board 17 is electrically coupled to the second electrode 16. Thereby, the second electrode 16 may be easily extracted from between the first, second boards 11, 12. Note that the second support board 17 may be omitted.

The first support board 15 and the second support board 17 are both not particularly limited, but e.g. various printed boards including flexible printed boards and rigid printed boards may be used.

As shown in FIG. 1, the pressurization unit 18 has the single screw 180 coupling the first board 11 and the second board 12. By adjusting an amount of fastening of the screw 180, the magnitude of the pressurization on the stacking structure 10 may be easily adjusted. Particularly, in the present embodiment, the stacking structure 10 has an annular shape with a through hole 101 formed in the center portion thereof, and the screw 180 is inserted into the through hole 101. By placing the screw 180 through the center portion of the stacking structure 10, the whole area of the stacking structure 10 may be pressurized with balance with the single pressurization unit 180. Note that the placement and the number of the screw 180 are not particularly limited. For example, a plurality of the screws 180 may be placed outside of the stacking structure 10 along a circumferential direction thereof.

As described above, the stacking structure 10 is pressurized by the pressurization unit 18, and thereby, hysteresis maybe reduced and variations of the detection value of the applied load may be reduced compared to the case without pressurization.

The graph shown in FIG. 3 is the graph showing resistance value changes between the first, second electrodes 14, 16 when the stacking structure 10 is not pressurized, and the graph shown in FIG. 4 is the graph showing resistance value changes between the first, second electrodes 14, 16 when the stacking structure 10 is pressurized. As can be seen from those graphs, when the stacking structure 10 is not pressurized, the resistance values are different between before and after the load application, however, when the stacking structure 10 is pressurized, the resistance values are barely different between before and after the load application. That is, almost no hysteresis is generated. Further, the graph shown in FIG. 5 is the graph showing variations of the detection value for the load actually applied when the stacking structure 10 is pressurized and not pressurized. As can be seen from the graph, the variations of the measurement value of the applied load may be further suppressed in the case with pressurization on the stacking structure 10 than in the case without pressurization. Particularly, the variation reduction effect for the smaller load (10 N in FIG. 5) is remarkable. From these result, it can be seen that when the stacking structure 10 is pressurized by the pressurization unit 18, hysteresis may be reduced and variations of the detection value of the applied load (particularly, the smaller load) maybe reduced compared to the case without pressurization.

Note that, in the experiments shown in FIGS. 4 and 5, the pressure-sensitive device 1 is used in which PC (polycarbonate) is used as the resin 131, the content percentage of the carbon nanotubes 132 in the resin mixture 13 is 20 wt %, and the resin mixture 13 has the thickness of 100 μm. In the experiment shown in FIG. 4, the stacking structure 10 is pressurized at 1.8 MPa. Further, in the experiment shown in FIG. 4, application/release of the load up to 60 N is repeated continuously for three times. FIG. 5 shows average values of measurements taken ten times with respect to each load of 10 N, 30 N, 50 N. Further, “variations” in FIG. 5 may be expressed by ΔF/F0, wherein an actually applied load (10 N, 30 N, 50 N in the graph) is F0 and a difference between F0, and a measurement value is ΔF.

The pressurization applied to the stacking structure 10 is not particularly limited, but e.g. preferably from 1 MPa to 15 MPa depending on the material of the resin mixture 13. Thereby, the above described variations of the detection value may be effectively reduced, and damage on the resin mixture due to excessive pressurization may be effectively suppressed. As below, optimum magnitude of pressurization within the above described range will be explained with respect to each material of the resin 131 of the resin mixture 13.

First, the case using PC (polycarbonate) as the resin 131 is explained. The graphs shown in FIGS. 6 to 9 are the graphs showing resistance value changes between the first, second electrodes 14, 16 when the magnitude of the pressurization is 1.4 MPa, 2.8 MPa, 7.1 MPa, 14.1 MPa. Note that, in the experiments shown in FIGS. 6 to 9, application/release up to 50 N are continuously repeated for three times. As can be seen from FIGS. 6 to 9, almost no hysteresis is generated in any one of the cases of pressurization.

The graph shown in FIG. 10 is the graph showing variations (ΔF/F0) of the detection value in the cases of pressurization at 1.4 MPa, 2.8 MPa, 7.1 MPa, and 14.1 MPa. It can be seen from FIG. 10 that the variations of the measurement value are sufficiently reduced when the pressurization is from 1.4 MPa to 14.1 MPa. Of the cases, particularly, the pressurization is preferably from 2.8 MPa to 14.1 MPa and more preferably from 2.8 MPa to 7.1 MPa. Thereby, the variations of the detection value may be reduced more effectively.

Next, the case using PP (polypropylene) as the resin 131 is explained. The graphs shown in FIGS. 11 to 14 are the graphs showing resistance value changes between the first, second electrodes 14, 16 when the magnitude of the pressurization is 2.8 MPa, 4.2 MPa, 7.1 MPa, 9.9 MPa. Note that, in the experiments shown in FIGS. 11 to 14, application/release up to 50 N are continuously repeated for three times. As can be seen from FIGS. 11 to 14, almost no hysteresis is generated in any one of the cases of pressurization.

The graph shown in FIG. 15 is the graph showing variations of the detection value in the cases of pressurization at 2.8 MPa, 4.2 MPa, 7.1 MPa, 9.9 MPa. It can be seen from FIG. 15 that variations of the measurement value are sufficiently reduced when the pressurization is from 2.8 MPa to 9.9 MPa. Of the cases, particularly, the pressurization is particularly preferably from 2.8 MPa to 4.2 MPa. Thereby, the variations of the detection value may be reduced more effectively.

Next, the case using PET (polyethylene terephthalate) as the resin 131 is explained. The graphs shown in FIGS. 16 to 19 are the graphs showing resistance value changes between the first, second electrodes 14, 16 when the magnitude of the pressurization is 1.4 MPa, 2.8 MPa, 4.2 MPa, 7.1 MPa. Note that, in the experiments shown in FIGS. 16 to 19, application/release up to 50 N are continuously repeated for three times. As can be seen from FIGS. 16 to 19, almost no hysteresis is generated in any one of the cases of pressurization.

The graph shown in FIG. 20 is the graph showing variations of the detection value in the cases of pressurization at 1.4 MPa, 2.8 MPa, 4.2 MPa, 7.1 MPa. It can be seen from FIG. 20 that variations of the measurement value are sufficiently reduced when the pressurization is from 1.4 MPa to 7.1 MPa. Of the cases, particularly, the pressurization is preferably from 2.8 MPa to 7.1 MPa and more preferably from 4.2 MPa to 7.1 MPa. Thereby, the variations of the detection value may be reduced more effectively.

As above, the pressure-sensitive device 1 is explained. As described above, the pressure-sensitive device 1 has the resin mixture 13 in which the carbon nanotubes are mixed, the first, second electrodes 14, 16 as electrodes stacked on the resin mixture 13, and the pressurization unit 18 that pressurizes the resin mixture 13 in the stacking direction. Further, the pressurization unit 18 includes the adjustment mechanism for adjusting the amount of pressurization. As described above, the stacking structure 10 is pressurized by the pressurization unit 18, and thereby, hysteresis maybe reduced and variations of the detection value of the applied load may be reduced compared to the case without pressurization.

Further, as described above, the pressurization unit 18 has the first board 11, the second board 12 placed along the direction in the stacking on the first board 11, and the screw 180 as the adjustment mechanism. The distance between the first board 11 and the second board 12 changes by turning of the screw 180, and thereby, the amount of pressurization is adjusted. Thus, the resin mixture 13 may be moderately pressurized. Note that the pressurization is not particularly limited, but preferably e.g. within a range from 1 MPa to 15 MPa. Thereby, the variations of the detection value may be effectively reduced and damage on the resin mixture 13 due to excessive pressurization may be effectively suppressed.

As described above, the carbon nanotube 132 has the diameter preferably within the range from 100 nm to 200 nm, and the length preferably within the range from 2 μm to 10 μm. With this diameter and the length, the resistance value change between the first, second electrodes 14, 16 relative to the change of the load applied to the pressure-sensitive device 1 is smoother and the amount of resistance value change between the first, second electrodes 14, 16 for the load applied to the pressure-sensitive device 1 is larger. Accordingly, the load applied to the pressure-sensitive device 1 may be detected with higher accuracy.

As described above, the content rate of the carbon nanotubes 132 in the resin mixture 13 is preferably within the range from 2 wt % to 30 wt %. Thereby, moderate conductivity may be provided to the resin mixture 13 and reduction of mechanical strength and difficulty of mixing in the resin mixture 13 due to excessive mixing of the carbon nanotubes 132 may be suppressed.

As described above, the resin 131 preferably contains PC (polycarbonate). When the resin 131 contains PC, the resin 131 is inexpensive, easy to handle, and easily mixed with the carbon nanotubes 132. Further, the resin mixture 13 is easily formed to be harder. Accordingly, allowable load per unit area may be higher and the mechanical strength of the pressure-sensitive device 1 may be improved, and the measurable range may be secured to be wider. In addition, deformation and settling with time of the resin mixture 13 may be suppressed, and degradation and fluctuations of the detection characteristics with time may be suppressed.

As described above, the resin 131 preferably contains at least one of PP (polypropylene), PET (polyethylene terephthalate), and PPS (polyphenylene sulfide). When the resin 131 contains at least one of PP, PET, and PPS, the resin 131 is inexpensive, easy to handle, and easily mixed with the carbon nanotubes 132 like PC. Further, the resin mixture 13 is easily formed to be harder. Accordingly, allowable load per unit area may be higher and the mechanical strength of the pressure-sensitive device 1 may be improved, and the measurable range may be secured to be wider. In addition, deformation and settling with time of the resin mixture 13 may be suppressed, and degradation and fluctuations of the detection characteristics with time may be suppressed.

As described above, the resin mixture 13 has the sheet-like shape, and the thickness of the resin mixture 13 is preferably within the range from 50 μm to 200 μm. Thereby, the sufficiently thin resin mixture 13 that sufficiently fulfills the function may be obtained. Accordingly, the pressure-sensitive device 1 may be downsized while maintaining detection characteristics of the pressure-sensitive device 1.

As described above, the Young's modulus of the resin mixture 13 is preferably within the range from 1.5 times to 2 times the Young's modulus of the resin 131. Thereby, the resin mixture 13 is sufficiently hard and the detectable range is wider, and higher loads may be detected. Further, excessive hardening may be suppressed and degradation of the detection characteristics may be effectively suppressed.

### Second Embodiment

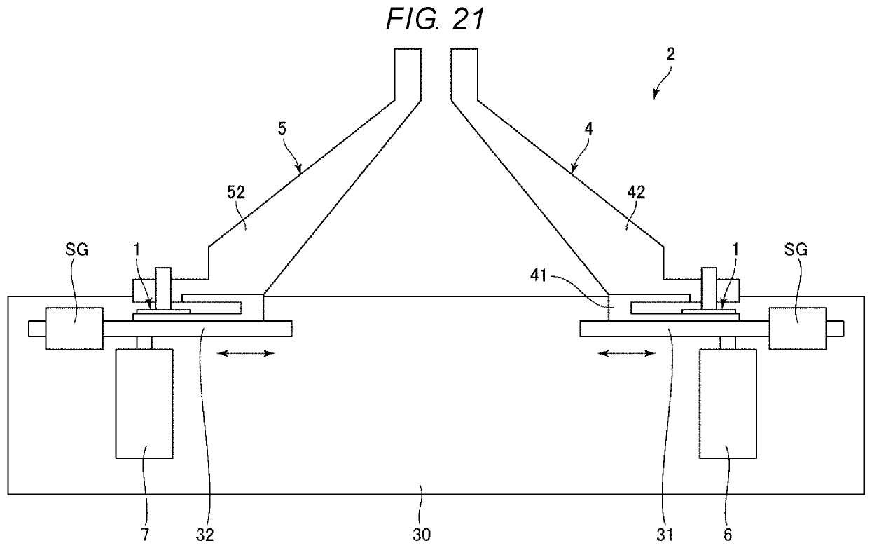

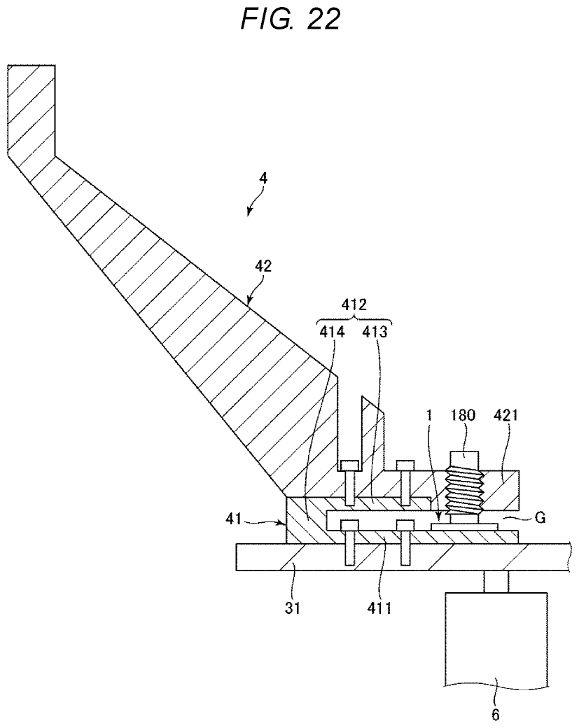

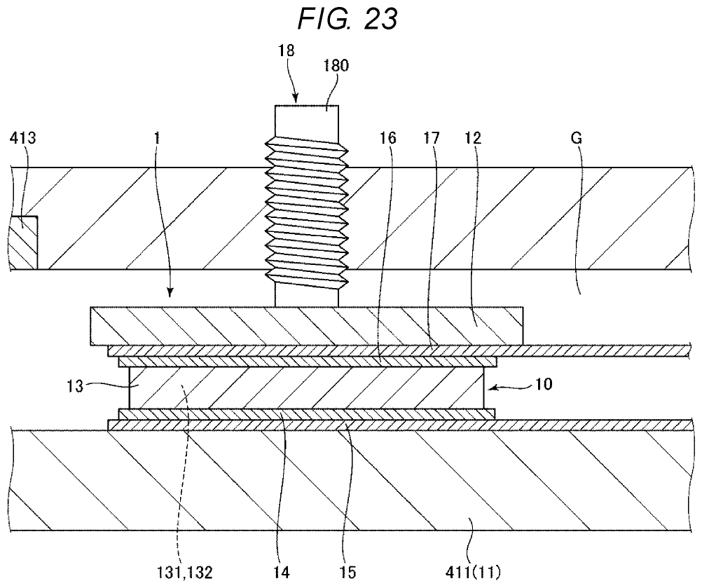

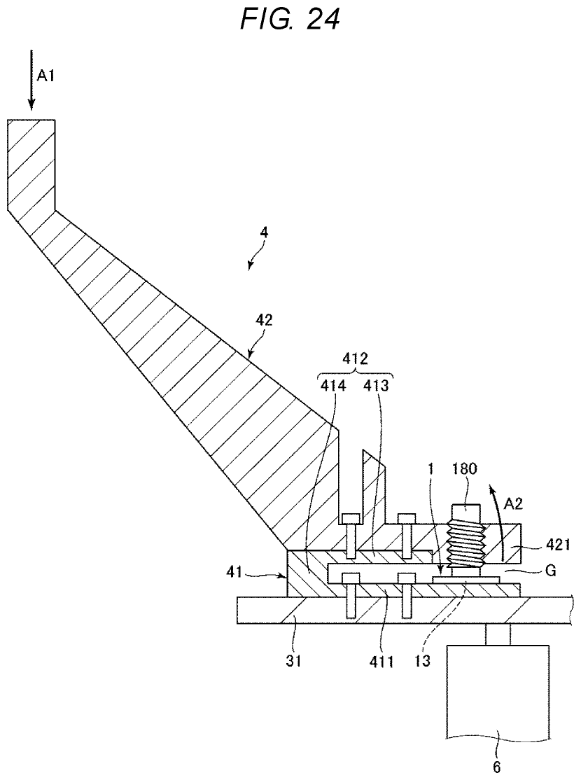

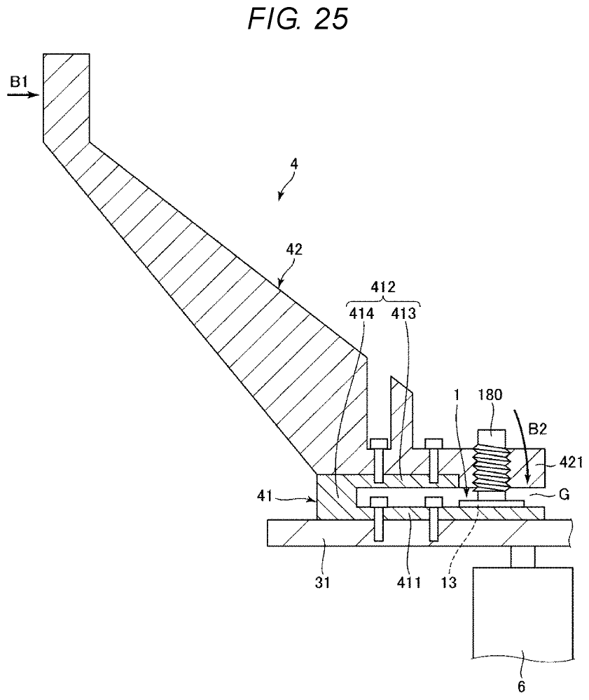

FIG. 21 is the plan view showing the hand according to the second embodiment of the present disclosure. FIG. 22 is the sectional view of the finger unit of the hand shown in FIG. 21. FIG. 23 is the sectional view of the pressure-sensitive device placed in the finger unit shown in FIG. 22. FIGS. 24 and 25 are respectively the sectional views for explanation of the mechanism of sensing the load by the pressure-sensitive device.

The hand 2 shown in FIG. 21 is a hand attached to e.g. a robot or the like and used, which may nip and grip an object from both sides. The hand 2 has a base 30, a pair of sliders 31, 32 slidably supported relative to the base 30, finger units 4, 5 fixed to the sliders 31, 32, and motors 6, 7 that slide the sliders 31, 32.

The sliders 31, 32 are supported by the base 30 via slide guides SG and slidable relative to the base 30 in directions of arrows in the drawing. Further, the motor 6 is coupled to the slider 31, and the slider 31 slides by driving of the motor 6. Similarly, the motor 7 is coupled to the slider 32, and the slider 32 slides by driving of the motor 7. The motors 6, 7 are not particularly limited, but e.g. piezoelectric motors maybe used. The sliders 31, 32 are moved by the motors 6, 7, and thereby, the finger units 4, 5 may grip the object and release the gripped object.

As below, the finger units 4, 5 will be explained using the finger unit 4 as a representative example and omitting the explanation of the finger unit 5, because the finger units 4, 5 have the same configuration as each other. As shown in FIG. 22, the finger unit 4 has a fixed part 41 fixed to the slider 31 and a nail part 42 fixed to the fixed part 41. Further, the fixed part 41 has a base portion 411 fastened to the slider 31 with screws and a stress transmission portion 412 coupled to the base portion 411. The stress transmission portion 412 has a displacement portion 413 placed to face the base portion 411 with an air gap in between, and a coupling portion 414 that couples one end of the displacement portion 413 and the base portion 411. When stress is applied to the displacement portion 413, the displacement portion 413 is displaced around the coupling portion 414 at a pivot point relative to the base portion 411. Note that the fastening method of the fixed part 41 to the slider 31 is not limited to fastening using screws.

The nail part 42 is fastened to the displacement portion 413 by screws and extends obliquely toward the finger unit 5 side. Further, the nail part 42 has a base portion 421 facing the base portion 411 with an air gap G in between. The pressure-sensitive device 1 is placed between the base portion 411 and the base portion 421. Note that the fastening method of the nail part 42 to the displacement portion 413 is not limited to fastening using screws.

As shown in FIG. 23, the pressure-sensitive device 1 has the first board 11 also serving as the base portion 411, the second board 12 placed to face the first board 11, the sheet-like resin mixture 13 placed between the first board 11 and the second board 12, the first electrode 14 placed between the first board 11 and the resin mixture 13, the first support board 15 located between the first board 11 and the first electrode 14 and supporting the first electrode 14, the second electrode 16 placed between the second board 12 and the resin mixture 13, the second support board 17 located between the second board 12 and the second electrode 16 and supporting the second electrode 16, and the pressurization unit 18 that pressurizes the stacking structure 10 as the stacking structure of the first electrode 14, the resin mixture 13, and the second electrode 16.

The pressurization unit 18 has the single screw 180, and the screw 180 is screwed into the base portion 421 of the nail part 42. The screw 180 is fastened and the second board 12 is pressed in the distal end portion of the screw 180, and thereby, the stacking structure 10 is pressurized. According to the configuration, by adjusting the amount of fastening of the screw 180, the magnitude of pressurization on the stacking structure 10 may be easily adjusted.

According to the configuration, for example, in the case where an action of pressing an object with the tip ends of the nail parts 42, 52 is performed or the like, as shown in FIG. 24, when stress of an arrow A1 is applied to the nail part 42, the displacement portion 413 is displaced around the coupling portion 414 as a pivot point as shown by an arrow A2. Accordingly, the air gap G between the base portion 411 and the base portion 421 becomes wider, and the force applied to the resin mixture 13 is reduced with the wider gap. On the other hand, for example, in the case where an action of gripping an object with the tip ends of the nail parts 42, 52 is performed or the like, as shown in FIG. 25, when stress of an arrow B1 is applied to the nail part 42, the displacement portion 413 is displaced around the coupling portion 414 as a pivot point as shown by an arrow B2. Accordingly, the air gap G between the base portion 411 and the base portion 421 becomes narrower, and the force applied to the resin mixture 13 is increased with the narrower gap. Therefore, according to the configuration, for example, the force applied by the action of pressing the object by the tip ends of the nail parts 42, 52 and the force applied by the action of gripping the object by the nail parts 42, 52 may be distinguished, and those forces may be detected with high accuracy.

As described above, the hand 2 has the pressure-sensitive device 1. Accordingly, the hand 2 may enjoy the advantages of the pressure-sensitive device 1 and may exert excellent reliability.

Note that the configuration of the hand 2 is not particularly limited. For example, the hand 2 of the embodiment has the two finger units 4, 5, however, the number of finger units may be one, three, or more. Further, in the hand 2 of the embodiment, the finger units 4, 5 respectively have the pressure-sensitive devices 1, however, one of the devices maybe omitted. That is, in the case where a plurality of finger units are provided, the pressure-sensitive device 1 may be placed in at least one finger unit. Furthermore, in the hand 2 of the embodiment, the pressure-sensitive devices are placed in the finger units 4, 5, however, the pressure-sensitive device 1 may be placed in the base 30, for example.

### Third Embodiment

Next, the robot according to the third embodiment of the present disclosure will be explained.

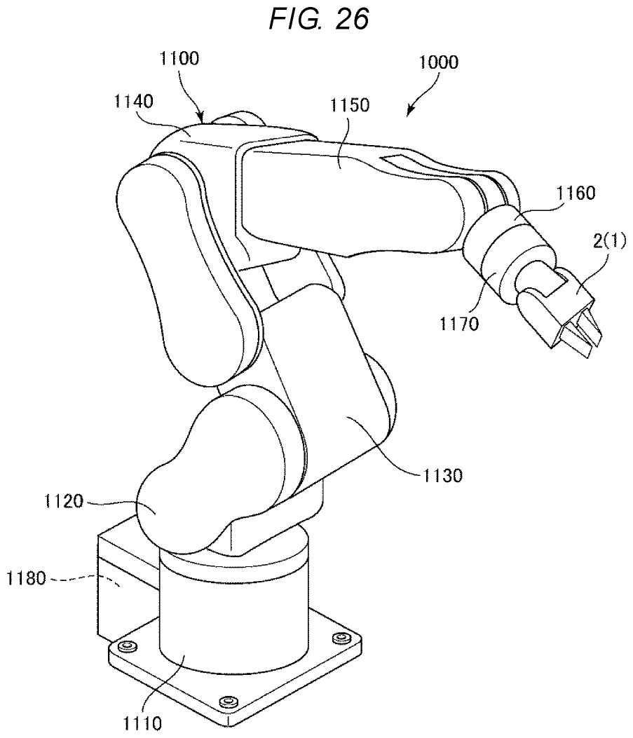

FIG. 26 is the perspective view showing the robot according to the third embodiment of the present disclosure.

The robot 1000 shown in FIG. 26 may perform work of feeding, removing, carrying, and assembly of precision apparatuses and components forming the apparatuses. The robot 1000 has a robot main body 1100, and the hand 2 attached to the robot main body 1100. The hand 2 has the pressure-sensitive device 1 as described in the second embodiment.

The robot main body 1100 is a six-axis robot, and has abase 1110 fixed to a floor or ceiling, an arm 1120 pivotably coupled to the base 1110, an arm 1130 pivotably coupled to the arm 1120, an arm 1140 pivotably coupled to the arm 1130, an arm 1150 pivotably coupled to the arm 1140, an arm 1160 pivotably coupled to the arm 1150, an arm 1170 pivotably coupled to the arm 1160, and a control apparatus 1180 that controls driving of these arms 1120, 1130, 1140, 1150, 1160, 1170. Further, a hand coupling part is provided in the arm 1170, and the hand 2 is attached to the hand coupling part as an end effector according to work to be executed by the robot main body 1100.

As described above, the robot 1000 has the pressure-sensitive device 1. Accordingly, the robot 1000 may enjoy the advantages of the pressure-sensitive device 1 and may exert excellent reliability.

The configuration of the robot 1000 is not particularly limited. For example, the number of arms may be one to five, seven, or more. Further, the robot 1000 may be a horizontal articulated robot (scalar robot) or dual-arm robot.

As above, the pressure-sensitive device, hand, and robot according to the present disclosure are explained based on the illustrated embodiments, however, the present disclosure is not limited to those, and the configurations of the respective parts may be replaced by arbitrary configurations having the same functions. Further, another arbitrary configuration may be added to the present disclosure. Furthermore, the respective embodiments may be appropriately combined.

What is claimed is:

1. A pressure-sensitive device comprising:
a resin mixture in which a carbon nanotube is mixed;
an electrode stacked on the resin mixture; and
a pressurization unit that pressurizes the resin mixture in a direction of the stacking, wherein
the pressurization unit includes an adjustment mechanism of adjusting an amount of the pressurization.

2. The pressure-sensitive device according to claim 1, wherein
the pressurization unit has a first board, a second board, and a screw as the adjustment mechanism, and
the resin mixture is placed between the first board and the second board along a direction of stacking,
a distance between the first board and the second board changes by turning of the screw, and thereby, the amount of pressurization is adjusted.

3. The pressure-sensitive device according to claim 1, wherein the carbon nanotube has a diameter within a range from 100 nm to 200 nm, and a length within a range from 2 μm to 10 μm.

4. The pressure-sensitive device according to claim 1, wherein a content percentage of the carbon nanotube in the resin mixture is within a range from 2 wt % to 30 wt %.

5. The pressure-sensitive device according to claim 1, wherein the resin mixture polycarbonate.

6. The pressure-sensitive device according to claim 1, wherein the resin mixture at least one of polypropylene, polyethylene terephthalate, and polyphenylene sulfide.

7. The pressure-sensitive device according to claim 1, wherein
the resin mixture has a sheet-like shape, and
a thickness of the resin mixture is within a range from 50 μm to 200 μm.

8. The pressure-sensitive device according to claim 1, wherein the pressurization is within a range from 1 MPa to 15 MPa.

9. A hand comprising the pressure-sensitive device according to claim 1.

10. A robot comprising the pressure-sensitive device according to claim 1.
